(19) United States
(12) Patent Application Publication
(10) Pub. No.: US 2022/0181608 A1
(43) Pub. Date: Jun. 9, 2022

(54) SELF-FILLED COATED SILICON-BASED COMPOSITE MATERIAL, METHOD FOR PREPARING SAME, AND USE THEREOF

(71) Applicant: Guangdong Kaijin New Energy Technology Co., Ltd., Dongguan (CN)

(72) Inventors: Anhua ZHENG, Dongguan (CN); Dexin YU, Dongguan (CN); Yongjun YANG, Dongguan (CN); Yunlin YANG, Dongguan (CN)

(73) Assignee: Guangdong Kaijin New Energy Technology Co., Ltd., Dongguan (CN)

(21) Appl. No.: 17/494,019

(22) Filed: Oct. 5, 2021

(30) Foreign Application Priority Data
Dec. 7, 2020 (CN) 202011418740.9
Jun. 9, 2021 (CN) 202110641324.3

(51) Int. Cl. H01M 4/36; H01M 4/48; H01M 10/0525; H01M 4/62

(52) U.S. Cl. CPC H01M 4/366; H01M 4/483; H01M 2004/021; H01M 4/625; H01M 4/628; H01M 10/0525

(57) ABSTRACT

The present invention relates to the field of anode materials for batteries, and in particular, relates to a self-filled coated silicon-based composite material. The self-filled coated silicon-based composite material is composed of a nano-silicon material, a filler material, and a surface modification material. The nano-silicon material has a particle size D50 being less than 200 nm; and the filler material is a carbon filler material filled among the nano-silicon material. The present invention provides the self-filled coated silicon-based composite material having the advantages of high initial efficiency, low expansion, long cycle, and the like. The present invention further provides a method for preparing the self-filled coated silicon-based composite material, and a use of the self-filled coated silicon-based composite material, which is simple and practicable in process and stable in product performance, and shows good application prospects.

### FIELD

The present invention relates to the field of anode materials for batteries, and in particular, relates to a self-filled coated silicon-based composite material, a method for preparing the same, and a use thereof.

### BACKGROUND

At present, commercial anode materials are mainly graphite materials such as natural graphite, artificial graphite, and intermediate phases thereof, which, however due to their low theoretic capacity (372 mAh/g), cannot meet the market needs. In recent years, the attention of people has focused on novel anode materials with a high specific capacity, such as lithium storage metals (such as Sn and Si) and oxides thereof, as well as lithium transition metal phosphides. Among numerous novel anode materials with a high specific capacity, Si due to its high theoretical specific capacity (4200 mAh/g) has become one of the most potential alternatives to graphite materials. However, Si-based materials show a great volumetric effect during a charge/discharge process, and are likely to undergo cracking and dusting to lose contact with a current collector, leading to a sharp decrease of cycle performance. In addition, the silicon-based materials have low intrinsic conductivity and poor rate performance. Therefore, how to reduce the volumetric expansion effect and improve the cycle performance and rate performance has great significance in the application of the silicon-based materials in lithium-ion batteries.

Current silicon/carbon anode materials are composite materials prepared by granulating nano-silicon materials, graphite, and carbon. Since the nano-silicon layer is coated on the surfaces of the graphite particles to form core-shell structures, micro-size graphite particles cannot release stresses well during a discharge process, which causes damages to local structures and affects the overall performance of the materials. Therefore, how to reduce the volumetric expansion effect and improve the cycle performance has great significance in the application of silicon-based materials in lithium-ion batteries.

### SUMMARY

To solve the technical problems described above, the present invention provides a self-filled coated silicon-based composite material with the advantages of high initial efficiency, low expansion, long cycle, and the like.

The present invention further provides a method for preparing the self-filled coated silicon-based composite material, and a use thereof. The self-filled coated silicon-based composite material is simple and practicable in process and stable in product performance, and shows good application prospects.

The present invention employs the following technical solution:

A self-filled coated silicon-based composite material is composed of a nano-silicon material, a filler material, and a surface modification material. The nano-silicon material has a particle size D50 being less than 200 nm; and the filler material is a carbon filler material filled among the nano-silicon material.

As a further improvement of the technical solution described above, the self-filled coated silicon-based composite material has a particle size D50 of 2-40 μm; the self-filled coated silicon-based composite material has a specific surface area of 0.5-15 m²/g; and the self-filled coated silicon-based composite material has a porosity of 1-20%.

As a further improvement of the technical solution described above, the self-filled coated silicon-based composite material has an oxygen content of 0-20%; the self-filled coated silicon-based composite material has a carbon content of 20-90%; and the self-filled coated silicon-based composite material has a silicon content of 5-90%.

As a further improvement of the technical solution described above, the nano-silicon material is nano-silicon particles or nano-silicon oxide particles; and the surface modification material is a carbon modification material, which comprises at least one layer with a monolayer thickness of 0.2-1.0 μm.

As a further improvement of the technical solution described above, the nano-silicon in the nano-silicon material is SiOₓ, with X being 0-0.8.

As a further improvement of the technical solution described above, the nano-silicon in the nano-silicon material has an oxygen content of 0-31%; and the nano-silicon in the nano-silicon material has a grain size of 1-40 nm.

A method for preparing a self-filled coated silicon-based composite material includes the following steps:

S0: evenly mixing and dispersing a nano-silicon material, a dispersant, and a binder in a solvent, and spraying and drying a resultant to prepare a precursor A;

S1: mechanically mixing and mechanically fusing the precursor A and an organic carbon source to prepare a precursor B;

S2: performing high-temperature vacuum/pressurized carbonization on the precursor B to prepare a precursor C;

S3: crushing and sieving the precursor C to prepare a precursor D; and

S4: performing carbon coating thermal treatment on the precursor D to prepare the self-filled coated silicon-based composite material.

As a further improvement of the technical solution described above, in Step S2, the high-temperature vacuum/pressurized carbonization includes one or more of vacuum carbonization, hot isostatic pressing, and post-pressurization carbonization.

As a further improvement of the technical solution described above, the carbon coating thermal treatment includes static thermal treatment or dynamic thermal treatment; the static thermal treatment includes: placing the precursor D in a chamber furnace, a vacuum furnace, or a roller kiln, raising the temperature of the precursor D to 400-1000° C. at a rate of 1-5° C./min under a protective atmosphere, preserving the heat for 0.5-20 h, and naturally cooling to room temperature; and the dynamic thermal treatment includes: placing the precursor D in a rotary furnace, raising the temperature to 400-1000° C. at a rate of 1-5° C./min under a protective atmosphere, introducing a gas from an organic carbon source at an introduction rate of 0-20.0 L/min, preserving the heat for 0.5-20 h, and naturally cooling to room temperature.

A use of a self-filled coated silicon-based composite material is provided, wherein the self-filled coated silicon-based composite material is applicable to an anode material of a lithium-ion battery.

The present invention has the following beneficial effects:

In the self-filled coated silicon-based composite material according to the present invention, the filler material forms a three-dimensional conductive carbon network, which not only can effectively improve the conductivity of the silicon-based material, but also can effectively alleviate a volumetric effect during a charge/discharge process, thereby effectively avoiding the dusting of the material during a cycle process; conductive carbon in the filler material not only can improve the conductivity of the material and alleviate the volumetric expansion of the nano-silicon material, but also can further reduce side reactions by preventing direct contact between the nano-silicon and electrolyte during the cycle process; and the outermost carbon coating layer can reduce side reactions by preventing direct contact between the nano-silicon and the electrolytes, and meanwhile, can further effectively increase the conductivity of the silicon-based material and alleviate the volumetric effect during the charge/discharge process.

### BRIEF DESCRIPTION OF THE DRAWINGS

FIG. 1 is a schematic structural diagram of a material prepared in Embodiment 4 of a self-filled coated silicon-based composite material according to the present invention;

FIG. 2 is a scanning electron microscope graph of the material prepared in Embodiment 4 of the self-filled coated silicon-based composite material according to the present invention; and

FIG. 3 is a diagram of initial charge/discharge curves of the material prepared in Embodiment 4 of the self-filled coated silicon-based composite material according to the present invention.

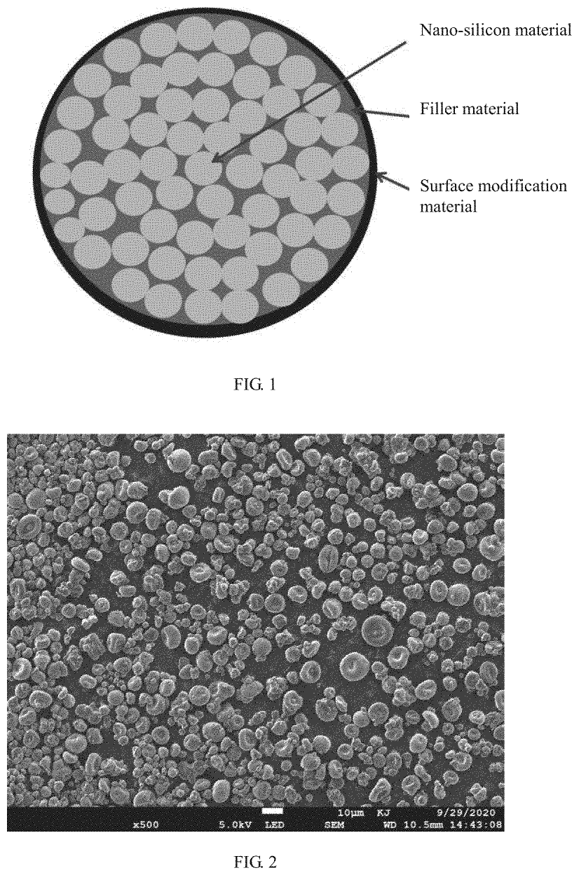

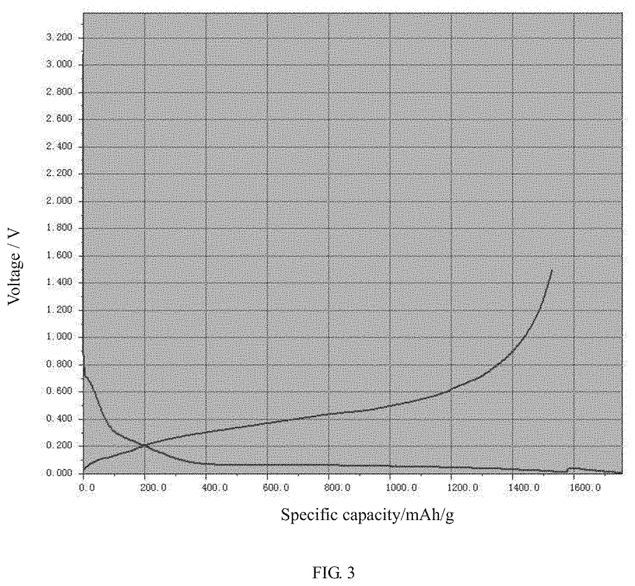

### DESCRIPTION OF THE EMBODIMENTS

The technical solutions in the embodiments of the present invention will be described clearly and completely below in conjunction with the embodiments of the present invention.

A self-filled coated silicon-based composite material is composed of a nano-silicon material, a filler material, and a surface modification material. The nano-silicon material has a particle size D50 being less than 200 nm; and the filler material is a carbon filler material filled among the nano-silicon material.

The self-filled coated silicon-based composite material has a particle size D50 of 2-40 μm, further preferably 2-20 μm, and particularly preferably 2-10 μm.

The self-filled coated silicon-based composite material has a specific surface area of 0.5-15 m²/g, further preferably 0.5-10 m²/g, and particularly preferably 0.5-5 m²/g.

The self-filled coated silicon-based composite material has a porosity of 1-20%, further preferably 1-10%, and particularly preferably 1-5%.

The self-filled coated silicon-based composite material has an oxygen content of 0-20%, further preferably 0-15%, and particularly preferably 0-10%.

The self-filled coated silicon-based composite material has a carbon content of 20-90%, further preferably 20-60%, and particularly preferably 20-50%.

The self-filled coated silicon-based composite material has a silicon content of 5-90%, further preferably 20-70%, and particularly preferably 30-60%.

The nano-silicon material is nano-silicon particles or nano-silicon oxide particles. The surface modification material is a carbon modification material, which comprises at least one layer, with a monolayer thickness of 0.2-1.0 μm.

The nano-silicon material is SiOx, with x being 0-0.8.

The nano-silicon material has an oxygen content of 0-31%, further preferably 0-20%, and particularly preferably 0-15%.

The nano-silicon material has a grain size of 1-40 nm. The nano-silicon material is one or both of polycrystalline nano-silicon and amorphous nano-silicon.

A method for preparing a self-filled coated silicon-based composite material includes the following steps:

S0: evenly mixing and dispersing nano-silicon material, a dispersant, and a binder in a solvent, and spraying and drying a resultant to prepare a precursor A;

S1: mechanically mixing and mechanically fusing the precursor A and an organic carbon source to prepare a precursor B;

S2: performing high-temperature vacuum/pressurized carbonization on the precursor B to prepare a precursor C;

S3: crushing and sieving the precursor C to prepare a precursor D; and

S4: performing carbon coating thermal treatment on the precursor D to prepare the self-filled coated silicon-based composite material.

In Step S2, the high-temperature vacuum/pressurized carbonization includes one or more of vacuum carbonization, hot isostatic pressing, and post-pressurization carbonization.

The carbon coating thermal treatment includes static thermal treatment or dynamic thermal treatment. The static thermal treatment includes: placing the precursor D in a chamber furnace, a vacuum furnace, or a roller kiln, raising the temperature to 400-1000° C. at a rate of 1-5° C./min under a protective atmosphere, preserving the heat for 0.5-20 h, and naturally cooling to room temperature. The dynamic thermal treatment includes: placing the precursor D in a rotary furnace, raising the temperature to 400-1000° C. at a rate of 1-5° C./min under a protective atmosphere, introducing a gas of organic carbon source at an introduction rate of 0-20.0 L/min, preserving the heat for 0.5-20 h, and naturally cooling to room temperature.

A use of a self-filled coated silicon-based composite material is provided, wherein the self-filled coated silicon-based composite material is applicable to an anode material of a lithium-ion battery.

### Embodiment 1

1. 1000 g of nano-silicon material with a particle size D50 of 100 nm and 100 g of citric acid were mixed and dispersed evenly in ethyl alcohol, and then sprayed and dried to prepare a precursor A1.

2. The precursor A1 and asphalt were mixed and fused at a mass ratio of 10:3 to prepare a precursor B1.

3. The precursor B1 was subsequently placed in a vacuum furnace, and sintered under a vacuum condition, where a temperature rise rate was 1° C./min, the thermal treatment was performed at the temperature of 1000° C., and the heat was preserved for 5 h; and a resultant was cooled to prepare a precursor C1, which was crushed and sieved to prepare a precursor D1.

4. The precursor D1 and asphalt were mixed and fused at a mass ratio of 10:1, and subsequently sintered under a condition of a nitrogen protective atmosphere, where a temperature rise rate was 1° C./min, the thermal treatment was performed at the temperature of 1000° C., and the heat was preserved for 5 h; and a resultant was cooled and then sieved to prepare the self-filled coated silicon-based composite material.

### Embodiment 2

1. 1000 g of nano-silicon material with a particle size D50 of 100 nm and 100 g of citric acid were mixed and dispersed evenly in ethyl alcohol, and then sprayed and dried to prepare a precursor A2.

2. The precursor A2 and asphalt were mixed and fused at a mass ratio of 10:3 to prepare a precursor B2.

3. The precursor B2 was subsequently placed in a hot isostatic pressing device to be thermally treated at the temperature of 1000° C.; the heat was preserved for 5 h; and a resultant was cooled to prepare a precursor C2, which was crushed and sieved to prepare a precursor D2.

4. The precursor D2 and asphalt were mixed and fused at a mass ratio of 10:1, and subsequently sintered under a condition of a nitrogen protective atmosphere, where a temperature rise rate was 1° C./min, the thermal treatment was performed at the temperature of 1000° C., and the heat was preserved for 5 h; and a resultant was cooled and then sieved to prepare the self-filled coated silicon-based composite material.

### Embodiment 3

1. 1000 g of nano-silicon material with a particle size D50 of 100 nm and 50 g of citric acid were mixed and dispersed evenly in ethyl alcohol, and then sprayed and dried to prepare a precursor A3.

2. The precursor A3 and asphalt were mixed and fused at a mass ratio of 10:3 to prepare a precursor B3.

3. The precursor B3 was subsequently placed in a vacuum furnace, and sintered under a vacuum condition, where a temperature rise rate was 1° C./min, the thermal treatment was performed at the temperature of 1000° C., and the heat was preserved for 5 h: and a resultant was cooled to prepare a precursor C3, which was crushed and sieved to prepare a precursor D3.

4. 1000 g of the prepared precursor D3 was placed in a CVD furnace and heated to 1000° C. at a temperature rise rate of 5° C./min; high-purity nitrogen and a methane gas were respectively introduced at rates of 4.0 L/min and 0.5 L/min, and a duration for introducing the high-purity nitrogen and the methane gas was 0.5 h; and a resultant was cooled and then sieved to prepare the self-filled coated silicon-based composite material.

### Embodiment 4

1. 1000 g of nano-silicon material with a particle size D50 of 100 nm and 50 g of citric acid were mixed and dispersed evenly in ethyl alcohol, and then sprayed and dried to prepare a precursor A4.

2. The precursor A4 and asphalt were mixed and fused at a mass ratio of 10:3 to prepare a precursor B4.

3. The precursor B4 was subsequently placed in a hot isostatic pressing device to be thermally treated at the temperature of 1000° C., the heat was preserved for 5 h; and a resultant was cooled to prepare a precursor C4, which was crushed and sieved to prepare a precursor D4.

4. 1000 g of the prepared precursor D4 was placed in a CVD furnace and heated to 1000° C. at a temperature rise rate of 5° C./min; high-purity nitrogen and a methane gas were respectively introduced at rates of 4.0 L/min and 0.5 L/min, and a duration for introducing the high-purity nitrogen and the methane gas was 0.5 h; and a resultant was cooled and then sieved to prepare the self-filled coated silicon-based composite material.

### Comparative Example

1. 1000 g of nano-silicon material with a particle size D50 of 100 nm and 100 g of citric acid were mixed and dispersed evenly in ethyl alcohol, and then sprayed and dried to prepare a precursor A0.

2. The precursor A0 and asphalt were mixed and fused at a mass ratio of 10:3 to prepare a precursor B0.

3. The precursor B0 was subsequently placed in a chamber furnace, and sintered under a condition of a nitrogen protective atmosphere, where a temperature rise rate was 1° C./min, the thermal treatment was performed at the temperature of 1000° C., and the heat was preserved for 5 h; and a resultant was cooled and then sieved to prepare a silicon-based composite material.

The embodiments and comparative example described above were tested in performance, with the test conditions as follows: each of the materials prepared in the comparative example and the embodiments was taken as an anode material and mixed with a binder polyvinylidene fluoride (PVDF) and a conductive agent (Super-P) at a mass ratio of 80:10.10; a proper amount of N-methylpyrrolidone (NMP) was added as a solvent to prepare a slurry, which was coated on a copper foil; the coated copper foil was vacuum-dried and rolled to prepare an anode piece; a metal lithium piece was used as a counter electrode, electrolyte prepared by using 1 mol/L of LiPF6 three-component mixed solvent at a mixing ratio of EC:DMC:EMC=1.1:1 (v/v) was used, and a polypropylene microporous membrane was used as a partition diaphragm; and a CR2032 type button battery was assembled in a glove box filled with an inert gas. Charge/discharge tests of the button batteries were performed on a battery test system in Landian Electronics (Wuhan) Co., Ltd. The charge/discharge occurred with the constant current of 0.1 C at normal temperature, and a charge/discharge voltage was limited to 0.005-1.5 V.

A method for testing and calculating a volumetric expansion rate of each of the materials was as follows: a composite material with a capacity of 500 mAh/g was prepared by compounding the prepared silicon/carbon composite material and graphite, and then tested in cycle performance, where an expansion rate:=(pole piece thickness after 50 cycles pole piece thickness before cycles)/(pole piece thickness before cycles−copper foil thickness)*100%.

Table 1 shows the results of initial-cycle tests of the comparative example and the embodiments, and Table 2 shows the results of the cyclic expansion tests.

TABLE 1

| | Initial charge | Initial discharge | Initial |
|---|---|---|---|
| | specific | specific | coulombic |
| | capacity | capacity | efficiency |
| | (mAh/g) | (mAh/g) | (%) |
| Comparative | 2003.2 | 1634.6 | 81.6 |
| Example | | | |
| Embodiment 1 | 1856.8 | 1574.6 | 84.8 |
| Embodiment 2 | 1826.4 | 1563.4 | 85.6 |
| Embodiment 3 | 1774.0 | 1534.5 | 86.5 |
| Embodiment 4 | 1748.8 | 1523.4 | 87.1 |

TABLE 2

| | Initial discharge | 50-cycle | 50-cycle |
|---|---|---|---|
| | specific | expansion | capacity |
| | capacity | rate | retention rate |
| | (mAh/g) | (%) | (%) |
| Comparative | 503.3 | 65.5 | 70.2 |
| Example | | | |
| Embodiment 1 | 500.7 | 55.5 | 81.2 |
| Embodiment 2 | 504.3 | 52.2 | 84.5 |
| Embodiment 3 | 502.6 | 53.4 | 85.4 |
| Embodiment 4 | 501.8 | 49.8 | 89.7 |

In the self-filled coated silicon-based composite material according to the present invention, the filled material forms a three-dimensional conductive carbon network, which not only can effectively improve the conductivity of the silicon-based material, but also can effectively alleviate a volumetric effect during a charge/discharge process, thereby effectively avoiding the dusting of the material during a cycle process; conductive carbon in the filled material not only can improve the conductivity of the material and alleviate the volumetric expansion of the nano-silicon material, but also can further reduce side reactions by preventing direct contact between the nano-silicon material and electrolyte during the cycle process; and the outermost carbon coating material can reduce side reactions by preventing direct contact between the nano-silicon material and the electrolyte, and meanwhile, can further effectively increase the conductivity of the silicon-based material and alleviate the volumetric effect during the charge/discharge process.

The embodiments above only provide specific and detailed descriptions of several implementations of the present invention, and therefore should not be construed to limit the patent scope of the present invention. It should be noted that several variations and improvements can be made by those of ordinary skill in the art without departing from the concept of the present invention, and shall be construed as falling within the protection scope of the present invention. Therefore, the patent protection scope of the present invention shall be subject to the accompanying claims.

What is claimed is:

1. A self-filled coated silicon-based composite material, wherein the self-filled coated silicon-based composite material is composed of a nano-silicon material, a filler material, and a surface modification material; the nano-silicon material has a particle size D50 being less than 200 nm; and the filler material is a carbon filler material filled among the nano-silicon material.

2. The self-filled coated silicon-based composite material according to claim 1, wherein the self-filled coated silicon-based composite material has a particle size D50 of 2-40 μm; the self-filled coated silicon-based composite material has a specific surface area of 0.5-15 m²/g; and
the self-filled coated silicon-based composite material has a porosity of 1-20%.

3. The self-filled coated silicon-based composite material according to claim 1, wherein the self-filled coated silicon-based composite material has an oxygen content of 0-20%, a carbon content of 20-90%, and a silicon content of 5-90%.

4. The self-filled coated silicon-based composite material according to claim 1, wherein the nano-silicon material is nano-silicon particles or nano-silicon oxide particles.

5. The self-filled coated silicon-based composite material according to claim 1, wherein the surface modification material is a carbon modification material and comprises at least one layer with a monolayer thickness of 0.2-1.0 μm.

6. The self-filled coated silicon-based composite material according to claim 1, wherein the nano-silicon material is SiOx, x being 0-0.8.

7. The self-filled coated silicon-based composite material according to claim 1, wherein the nano-silicon material has an oxygen content of 0-31%; and the nano-silicon material has a grain size of 1-40 nm.

8. A method for preparing a self-filled coated silicon-based composite material, comprising the following steps:
S0: evenly mixing and dispersing a nano-silicon material, a dispersant, and a binder in a solvent, and spraying and drying a resultant to prepare a precursor A;
S1: mechanically mixing and mechanically fusing the precursor A and an organic carbon source to prepare a precursor B;
S2: performing high-temperature vacuum/pressurized carbonization on the precursor B to prepare a precursor C;
S3: crushing and sieving the precursor C to prepare a precursor D; and
S4: performing carbon coating thermal treatment on the precursor D to prepare the self-filled coated silicon-based composite material.

9. The method for preparing the self-filled coated silicon-based composite material according to claim 8, wherein in Step S2, the high-temperature vacuum/pressurized carbonization comprises one or more of vacuum carbonization, hot isostatic pressing, and post-pressurization carbonization.

10. The method for preparing the self-filled coated silicon-based composite material according to claim 8, wherein the carbon coating thermal treatment comprises static thermal treatment or dynamic thermal treatment.

11. The method for preparing the self-filled coated silicon-based composite material according to claim 10, wherein the static thermal treatment comprises: placing the precursor D in a chamber furnace, a vacuum furnace, or a roller kiln; heating the precursor D to a temperature of 400-1000° C. at a rate of 1-5° C./min under a protective atmosphere, and preserving the temperature for 0.5-20 h, and naturally cooling to room temperature.

12. The method for preparing the self-filled coated silicon-based composite material according to claim 10, wherein and the dynamic thermal treatment comprises: placing the precursor D in a rotary furnace, heating the rotary furnace to a temperature of 400-1000° C. at a rate of 1-5° C./min under a protective atmosphere, introducing a gas of organic carbon source at an introduction rate of 0-20.0 L/min, preserving the temperature for 0.5-20 h, and naturally cooling to room temperature.

13. A use of the self-filled coated silicon-based composite material according to claim 1, wherein the self-filled coated silicon-based composite material is applicable to an anode material of a lithium-ion battery.
